(19) United States
(12) Patent Application Publication
(10) Pub. No.: US 2026/0350388 A1
(43) Pub. Date: Nov. 5, 2026

(54) JOINTLY TRAINING MODEL PARAMETERS AND REGULARIZATION PARAMETERS OF MACHINE LEARNING MODELS

(71) Applicant: Carlos Stein Naves de Brito, Lisbon (PT)

(72) Inventor: Carlos Stein Naves de Brito, Lisbon (PT)

(21) Appl. No.: 19/655,118

(22) Filed: Apr. 22, 2026

Related U.S. Application Data
(60) Provisional application No. 63/792,970, filed on Apr. 23, 2025.

(51) Int. Cl. G06N 3/08; G06N 3/045

(52) U.S. Cl. CPC G06N 3/08; G06N 3/045

(57) ABSTRACT

Methods, systems, and computer-readable media for training a machine learning model comprising a first set of parameters and a second set of parameters disjoint from the first set. Training proceeds over a plurality of iterations. In each iteration, a first gradient of a first loss computed on a first dataset updates the first set of parameters, and a second gradient of a second loss computed on a second disjoint dataset updates the second set of parameters using the first set as updated in the iteration. The second set may comprise noise magnitudes, penalty strengths, dropout parameters, augmentation parameters, or attention temperatures, at any granularity. A Monte Carlo asymmetric embodiment provides gradients for stochastic regularizers. A gradient decomposition embodiment handles non-smooth regularizers. Training produces models with reduced expected calibration error without post-training calibration.

### CROSS-REFERENCE TO RELATED APPLICATION

This application claims priority to U.S. Provisional Application No. 63/792,970, filed on Apr. 23, 2025. The disclosure of the prior application is considered part of and is incorporated by reference in the disclosure of this application.

### BACKGROUND

This specification relates to training machine learning models.

Machine learning models receive an input and generate an output, e.g., a predicted output, based on the received input. Some machine learning models are parametric models and generate the output based on the received input and on values of the parameters of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output.

Machine learning models have parameters whose values determine how the machine learning models process inputs to generate outputs. Values of the parameters of a machine learning model are learned during a training process, in which values of the parameters are adjusted based on training data so that the machine learning model produces outputs that are consistent with target outputs associated with inputs in the training data. Values of the parameters are typically adjusted by computing gradients of a loss function of the machine learning model with respect to the parameters and adjusting the values of the parameters based on the computed gradients.

In addition to the parameters of the machine learning model, a training process for a machine learning model is typically governed by one or more hyperparameters. A hyperparameter is a variable that controls an aspect of the training process but whose value is not adjusted by the gradient-based training process that adjusts values of the parameters of the machine learning model. Examples of hyperparameters include a learning rate, a number of training iterations, and a regularization strength that controls an amount of regularization applied to the machine learning model during training. Values of hyperparameters are conventionally selected by training multiple candidate machine learning models each having different values of the hyperparameters and selecting among the trained candidate machine learning models based on performance, or by computing hypergradients of a training objective with respect to the hyperparameters through a training trajectory of the parameters of the machine learning model.

Machine learning models can be subject to overfitting, in which a machine learning model fits training data closely at the expense of generalization to data not in the training data. Regularization is a class of techniques used to reduce overfitting. Conventional regularization techniques rely on hyperparameters, selected as described above, to control an amount of regularization applied to the machine learning model.

### SUMMARY

This specification describes how a system implemented as computer programs on one or more computers in one or more locations can train a machine learning model having both a set of model parameters and a set of regularization parameters, by adjusting values of the set of model parameters using training data and adjusting values of the set of regularization parameters using regularization data. The regularization data may be disjoint from the training data. The set of regularization parameters are parameters of the machine learning model, in that values of the set of regularization parameters, together with values of the set of model parameters, determine outputs of the machine learning model. However, unlike hyperparameters of a training process, values of which are selected outside of a gradient-based training process, values of the set of regularization parameters are adjusted during training of the machine learning model by gradient descent using gradients of a measure of performance of the machine learning model on the regularization data with respect to the set of regularization parameters. The regularization data is used to compute these gradients, rather than being used only to evaluate a trained machine learning model or to select among candidate values of hyperparameters after training of candidate machine learning models has been performed.

In general, one innovative aspect may be embodied in a computer-implemented method of training a machine learning model, wherein processing an input using the machine learning model to generate an output depends on both (i) values of a set of model parameters of the machine learning model and (ii) values of a set of regularization parameters of the machine learning model, and wherein the values of the set of regularization parameters control an amount of regularization of the machine learning model, the method comprising: obtaining training data and regularization data; during an iterative training process for the machine learning model, iteratively performing: (a) adjusting the values of the set of model parameters by computing, on the training data and with respect to the set of model parameters, gradients of a first measure of performance of the machine learning model, and updating the values of the set of model parameters based on the computed gradients; and (b) adjusting the values of the set of regularization parameters by computing, on the regularization data and with respect to the set of regularization parameters, gradients of a second measure of performance of the machine learning model, and updating the values of the set of regularization parameters based on the computed gradients; wherein the amount of regularization of the machine learning model is thereby adapted during the iterative training process based on performance of the machine learning model on the regularization data.

In some implementations, training the set of model parameters comprises, for each training example in the training data: processing the training example using the machine learning model in accordance with current values of the set of model parameters and the set of regularization parameters to determine a model output; determining a gradient, with respect to the set of model parameters, of the measure of performance on the training data using the model output and a target output for the training example; and adjusting the current values of the set of model parameters using the gradient. Training the set of regularization parameters comprises, for each regularization example in the regularization data: processing the regularization example using the machine learning model to determine a model output; determining a gradient, with respect to the set of regularization parameters, of the measure of performance on the regularization data using the model output and a target output for the regularization example; and adjusting the current values of the set of regularization parameters using the gradient. The gradients are first-order gradients computed by backpropagation through the machine learning model, without computing higher-order derivatives through a training trajectory of the set of model parameters.

In some implementations, the set of model parameters and the set of regularization parameters are disjoint subsets of parameters of the machine learning model. Gradients computed from performance of the machine learning model on the training data update values of the set of model parameters, while gradients computed from performance of the machine learning model on the regularization data update values of the set of regularization parameters.

In some implementations, updates to values of one or more parameters of the machine learning model during training are decomposed into a first component and a second component, wherein the first component is along a direction orthogonal to a direction of change of a scalar function of the parameters and the second component is along the direction of change of the scalar function. Gradients computed from performance of the machine learning model on the training data are constrained to the first component, and gradients computed from performance of the machine learning model on the regularization data are constrained to the second component. The scalar function of the parameters may be, for example, a norm of weights of the machine learning model, such as an L1 norm, an L2 norm, or an elastic net norm; another norm of the parameters; or another scalar function of the parameters whose value represents a regularization quantity. In this manner, the set of model parameters corresponds to adjustments of the parameters that do not change the scalar function, and the set of regularization parameters corresponds to adjustments of the parameters that do change the scalar function.

In some implementations in which the machine learning model has weights subject to a norm-based regularization, the weights are represented as a product of a direction parameter and a magnitude parameter, wherein the direction parameter is a unit vector and the magnitude parameter is a scalar that determines a norm of the weights. The direction parameter is included in the set of model parameters and the magnitude parameter is included in the set of regularization parameters. Training the direction parameter using the training data adjusts a direction of the weights based on performance on the training data, and training the magnitude parameter using the regularization data adjusts the norm of the weights based on performance on the regularization data.

In some implementations, the set of regularization parameters comprises a noise magnitude that parameterizes a noise distribution from which samples are drawn and applied to activations, weights, or inputs of the machine learning model during processing of inputs. The set of regularization parameters may further comprise a variance parameter of an output distribution of the machine learning model; a temperature parameter applied to outputs of the machine learning model; a label smoothing strength that parameterizes a mixing between target outputs of the machine learning model and a reference distribution over target outputs; a data augmentation perturbation magnitude that parameterizes a distribution over perturbations applied to training examples; a dropout probability that parameterizes a distribution over dropout masks applied to activations of the machine learning model during processing of inputs; or another parameter of the machine learning model whose value governs a regularizing effect on operation of the machine learning model.

In some implementations, gradients with respect to a regularization parameter that parameterizes a continuous distribution are computed using a reparameterization trick in which samples from the distribution are expressed as a deterministic function of the regularization parameter and samples from a fixed base distribution. In some implementations in which a regularization parameter parameterizes a discrete distribution, such as a dropout probability, a continuous relaxation of the discrete distribution, such as a concrete distribution or a Gumbel-softmax distribution, is used during training of the regularization parameter to enable computation of gradients with respect to the regularization parameter.

In some implementations in which the machine learning model comprises a stochastic component parameterized by one or more regularization parameters in the set of regularization parameters, the stochastic component is sampled a greater number of times per example when computing the measure of performance of the machine learning model on the regularization data than when computing the measure of performance of the machine learning model on the training data. For example, the measure of performance on the training data may be computed by sampling the stochastic component once per training example and computing a loss using an output produced by the machine learning model from the sample, while the measure of performance on the regularization data is computed by sampling the stochastic component a plurality of times per regularization example, aggregating outputs of the machine learning model across the plurality of samples, and computing a loss using the aggregated output. Computing the measure of performance on the training data by sampling the stochastic component fewer times maintains a regularizing effect of the stochastic component during training of the set of model parameters, while computing the measure of performance on the regularization data by sampling the stochastic component more times and aggregating the samples approximates a performance of the machine learning model with the stochastic component integrated out, which is the quantity relevant for generalization to data outside the training data.

In some implementations, the set of regularization parameters comprises parameters of a predictive distribution of the machine learning model, wherein the predictive distribution is a distribution over possible outputs of the machine learning model given an input. Training the parameters of the predictive distribution using the regularization data adjusts the predictive distribution so that a likelihood of regularization examples under the predictive distribution is improved. The resulting trained machine learning model produces a predictive distribution that is calibrated with respect to data outside the training data, such that the predictive distribution can be used to represent uncertainty of the machine learning model at test time.

In some implementations, the set of regularization parameters comprises a single regularization parameter that controls regularization globally across the machine learning model. In some other implementations, the set of regularization parameters comprises multiple regularization parameters, wherein different regularization parameters in the set control regularization of different parts of the machine learning model. For example, the machine learning model may comprise a plurality of layers, and the set of regularization parameters may comprise, for each of the plurality of layers, one or more regularization parameters that control regularization of the layer. As a further example, the machine learning model may comprise individual parameters that each have an associated regularization parameter in the set of regularization parameters.

In some implementations, the training data and the regularization data are drawn from a non-stationary distribution in which a distribution of inputs, a distribution of target outputs, or both, changes over time during training. By adjusting values of the set of regularization parameters based on performance on current regularization data throughout training, the machine learning model adapts the regularization to the current distribution of the training data and the regularization data. The machine learning model thereby adjusts an amount of regularization in response to distribution shifts in the training data and the regularization data without requiring explicit detection of the distribution shifts or restarting of training.

In some implementations, adjusting values of the set of model parameters and adjusting values of the set of regularization parameters are performed in alternation, with each adjustment using a respective batch of examples from the corresponding data. In some implementations, adjusting values of the set of regularization parameters is performed less frequently than adjusting values of the set of model parameters. In some implementations, the set of regularization parameters comprises a plurality of groups of regularization parameters, and different groups are adjusted in separate adjustment operations. In some implementations, different groups of regularization parameters are adjusted at different frequencies during training.

In some implementations, obtaining the training data and the regularization data comprises partitioning a dataset into the training data and the regularization data, wherein a fraction of the dataset is used as the regularization data and a remainder of the dataset is used as the training data. In some implementations, the fraction of the dataset used as the regularization data is in a range from approximately 1% to approximately 30%. In some implementations, the training data and the regularization data are drawn from separate data sources. In some implementations, the partitioning is performed using a k-fold cross-validation scheme in which multiple partitions of the dataset into training data and regularization data are used in succession during training.

In some implementations, the machine learning model comprises a neural network. The neural network may comprise a feedforward neural network, a convolutional neural network, a recurrent neural network, a transformer neural network, another neural network architecture, or a combination thereof. The machine learning model may be configured to perform a classification task, a regression task, a structured prediction task, a generative modeling task, an uncertainty quantification task, or another machine learning task.

In some implementations, the method further comprises providing the trained machine learning model for use in processing data after training the set of model parameters and the set of regularization parameters. During inference by the trained machine learning model, both the set of model parameters and the set of regularization parameters are used to generate outputs from inputs.

The above aspects can be implemented in any convenient form. For example, aspects and implementations may be implemented by appropriate computer programs which may be carried on appropriate carrier media which may be tangible carrier media (e.g., disks) or intangible carrier media (e.g., communications signals). Aspects may also be implemented using suitable apparatus which may take the form of programmable computers running computer programs.

Particular embodiments of the subject matter described in this specification can be implemented so as to realize one or more of the following advantages. Training a machine learning model as described in this specification can train the machine learning model with values of regularization parameters that improve generalization performance of the machine learning model in a single training process, without training multiple candidate machine learning models each having different values of hyperparameters, without computing higher-order derivatives of a training objective through a training trajectory of the parameters of the machine learning model, and without storing intermediate states of the parameters across training iterations, thereby reducing the amount of processing time, computational resources, and memory required by a training system relative to conventional approaches that select hyperparameter values by training multiple candidate machine learning models or by computing hypergradients through a training trajectory. Training a machine learning model as described in this specification further enables adaptive per-part regularization of the machine learning model during training, in which values of different regularization parameters associated with different parts of the machine learning model are adjusted during training based on a measure of performance of the machine learning model on regularization data, without manual selection of different regularization strengths for different parts of the machine learning model.

Many conventional approaches select values of hyperparameters that control regularization by training multiple candidate machine learning models each having different values of the hyperparameters and selecting among the trained candidate machine learning models based on performance. Other approaches compute hypergradients of a training objective through a training trajectory of the model parameters with respect to hyperparameters that control regularization, involving higher-order derivatives and storage of intermediate states of the model parameters. Each of these approaches can be computationally expensive. By directly adjusting values of the regularization parameters using regularization data during training of the machine learning model as described in this specification, training multiple candidate machine learning models and computing hypergradients through a training trajectory can both be avoided. Systems that need to train machine learning models with appropriate regularization can do so while using less of their computational resources and having reduced system complexity. For example, by training a single machine learning model in which values of the regularization parameters are adjusted using the regularization data rather than training multiple candidate machine learning models each having different values of the regularization parameters and selecting among the trained candidate machine learning models, only one training process needs to be performed rather than multiple different training processes, reducing the amount of processing time and memory required while maintaining acceptable generalization performance.

In some implementations, the regularization parameters include parameters of a predictive distribution of the machine learning model. Adjusting such regularization parameters using the regularization data during training produces a calibrated predictive distribution from a single trained machine learning model. Many conventional approaches to producing calibrated predictive distributions train multiple independent machine learning models and aggregate outputs of the multiple trained models to estimate uncertainty. These approaches involve multiple separate training processes and require storing and performing inference through multiple machine learning models. By producing a calibrated predictive distribution from a single trained machine learning model as described in this specification, training and inference through multiple machine learning models can be avoided, further reducing processing time and memory required.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system for training a machine learning model using training data and regularization data.

FIG. 2 illustrates an example partitioning of parameters of a machine learning model into a set of model parameters and a set of regularization parameters by functional role.

FIG. 3 illustrates an example asymmetric treatment of a stochastic component of a machine learning model during training using training data and regularization data, in which the stochastic component is sampled a greater number of times per example when computing a measure of performance on the regularization data than when computing a measure of performance on the training data.

FIG. 4 is a diagram illustrating an example decomposition of a gradient into a first component along a direction orthogonal to a regularization direction and a second component along the regularization direction in a parameter space of weights of a machine learning model.

### DETAILED DESCRIPTION

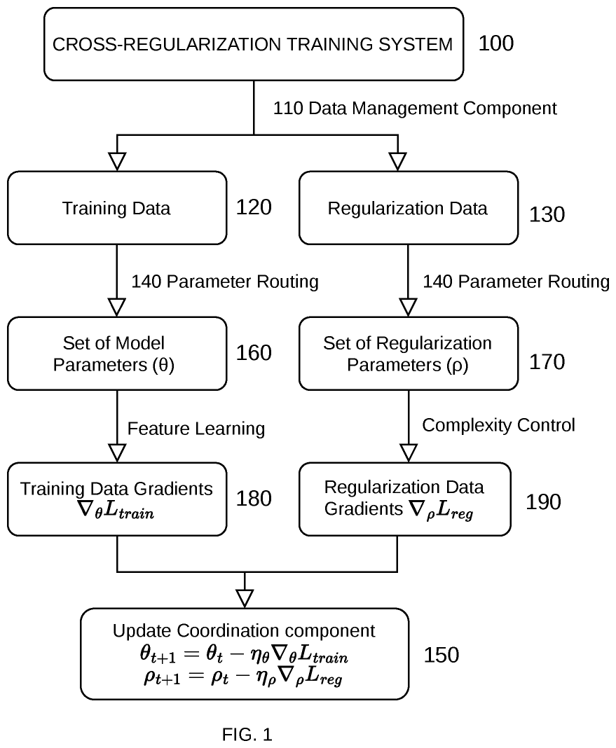

FIG. 1 shows an example cross-regularization training system 100. The cross-regularization training system 100, also referred to in this specification as the training system 100, is an example of a system implemented as computer programs on one or more computers in one or more locations, in which the systems, components, and techniques described below can be implemented.

The training system 100 is a system that trains a machine learning model by adjusting values of a set of model parameters 160 of the machine learning model using training data 120 and adjusting values of a set of regularization parameters 170 of the machine learning model using regularization data 130. The training data 120 and the regularization data 130 are disjoint, in that no example in the regularization data 130 is also an example in the training data 120. After training, the training system 100 generates data specifying a trained machine learning model, which can be used to generate outputs from new inputs using both the set of model parameters 160 and the set of regularization parameters 170.

The set of model parameters 160 and the set of regularization parameters 170 together determine outputs of the machine learning model. That is, processing an input using the machine learning model to determine an output depends on both the current values of the set of model parameters 160 and the current values of the set of regularization parameters 170. Values of the set of regularization parameters 170 control an amount of regularization of the machine learning model. As used in this specification, the amount of regularization of the machine learning model refers to a degree to which operation of the machine learning model is constrained, smoothed, or otherwise regulated to reduce overfitting of the machine learning model to the training data 120.

The training data 120 comprises training examples, each of which comprises an input and, in some implementations, a corresponding target output. The regularization data 130 comprises regularization examples, each of which comprises an input and, in some implementations, a corresponding target output. The training data 120 and the regularization data 130 are data drawn from a same data distribution or from related data distributions relevant to a task being learned by the machine learning model.

As used in this specification, the regularization data 130 is referred to as regularization data rather than as validation data, because the regularization data 130 is actively used to compute gradients that directly update the set of regularization parameters 170 through gradient descent during training of the machine learning model. This is distinguished from a conventional use of validation data, in which validation data is used only to evaluate a trained model or to select among candidate values of hyperparameters after training of candidate models.

As used in this specification, “regularization parameters” refers to parameters of the machine learning model, or parameters of a stochastic component or a predictive distribution component used by the machine learning model to generate outputs, whose values govern a regularizing effect on operation of the machine learning model and whose values are adjusted during training based on a measure of performance of the machine learning model on regularization data. Regularization parameters are not hyperparameters. Hyperparameters include variables that govern execution of a training algorithm, such as a learning rate, a batch size, or a number of training iterations, and variables that appear in a training objective as coefficients multiplying regularization terms, such as a coefficient λ multiplying a norm of weights in a regularized loss function; values of hyperparameters are selected outside of the gradient-based training process that adjusts values of the parameters of the machine learning model. The training of the machine learning model described in this specification controls the regularizing effect on operation of the machine learning model through the regularization parameters, adjusted during training by gradient descent on the regularization data, rather than through hyperparameters selected outside the training process. Regularization parameters parameterize regularization operations applied to operation of the machine learning model during processing of inputs, including but not limited to a noise distribution applied to activations, weights, or inputs of the machine learning model, a dropout distribution applied to activations of the machine learning model, a label smoothing operation applied to target outputs of the machine learning model, a data augmentation operation applied to training examples, or a predictive distribution component that generates a distribution over possible outputs of the machine learning model. Regularization parameters are distinguished from architecture parameters of the machine learning model that select among alternative architectural configurations of the machine learning model, such as alternative operations at nodes of a directed acyclic graph representation of the machine learning model.

The training system 100 comprises a data management component 110, a parameter routing component 140, and an update coordination component 150. The components of the training system 100 may be implemented as software modules executing on one or more computers, as special-purpose hardware, or as a combination of software and hardware.

The data management component 110 is responsible for obtaining the training data 120 and the regularization data 130 from one or more data sources, partitioning a dataset into the training data 120 and the regularization data 130 when partitioning is performed, and providing batches of examples from the training data 120 and the regularization data 130 to downstream components of the training system 100 for use in training the machine learning model.

In some implementations, the data management component 110 partitions a dataset into the training data 120 and the regularization data 130 by designating a fraction of the dataset as the regularization data 130 and a remainder of the dataset as the training data 120. The fraction may vary depending on characteristics of the dataset. In some implementations, the fraction is in a range from approximately 1 percent to approximately 30 percent. For example, the fraction may be approximately 1 percent for a large dataset such as a dataset used for image classification with noise regularization, or may be in a range from approximately 20 percent to approximately 30 percent for a smaller dataset. Other proportions that provide sufficient gradient signal for training the set of regularization parameters 170 may also be used.

In some other implementations, the training data 120 and the regularization data 130 are drawn from separate data sources rather than being obtained by partitioning a single dataset. For example, the training data 120 may be obtained from one data source, and the regularization data 130 may be obtained from a second data source containing examples drawn from a related data distribution.

In some implementations, the data management component 110 employs a k-fold cross-validation scheme in which multiple partitions of a dataset into training data 120 and regularization data 130 are used in succession during training. For each of a plurality of folds, the data management component 110 designates a respective fraction of the dataset as the regularization data 130 for the fold and the remainder of the dataset as the training data 120 for the fold. The training system 100 then trains the machine learning model for the fold using the training data 120 and regularization data 130 for the fold. In some implementations, the training system 100 aggregates results across the plurality of folds.

In some implementations in which the machine learning model processes streaming data, the data management component 110 generates batches of training data 120 and regularization data 130 from incoming streaming data and provides the batches to downstream components of the training system 100.

The parameter routing component 140 identifies and tracks which parameters of the machine learning model are in the set of model parameters 160 and which parameters are in the set of regularization parameters 170, and computes and routes gradients between the training data 120, the regularization data 130, and the corresponding sets of parameters. Specifically, the parameter routing component 140 computes training data gradients 180, which are gradients of a measure of performance of the machine learning model on the training data 120 with respect to the set of model parameters 160, and applies the training data gradients 180 to the set of model parameters 160. The parameter routing component 140 also computes regularization data gradients 190, which are gradients of a measure of performance of the machine learning model on the regularization data 130 with respect to the set of regularization parameters 170, and applies the regularization data gradients 190 to the set of regularization parameters 170, in coordination with the update coordination component 150.

The parameter routing component 140 may categorize parameters based on their functional role in operation of the machine learning model, with parameters that determine features extracted from inputs to the machine learning model being categorized in the set of model parameters 160 and parameters that control an amount of regularization of the machine learning model being categorized in the set of regularization parameters 170. In some implementations, the parameter routing component 140 maintains the set of model parameters 160 and the set of regularization parameters 170 as disjoint groups of parameters. In some other implementations, the parameter routing component 140 supports gradient decomposition approaches, as described below, in which the set of model parameters 160 and the set of regularization parameters 170 correspond to adjustments of a common set of weights of the machine learning model along different directions in a parameter space, rather than to disjoint groups of parameters. In implementations using gradient decomposition, the parameter routing component 140 decomposes gradients into components along different directions and routes the components accordingly, as described below.

The parameter routing component 140 may also enforce constraints on parameters, such as positivity constraints for a variance parameter in the set of regularization parameters 170, constraints that a direction parameter in the set of model parameters 160 is a unit vector, or constraints that a dropout probability in the set of regularization parameters 170 is between zero and one.

The update coordination component 150 manages the schedule by which the set of model parameters 160 and the set of regularization parameters 170 are adjusted during training. In some implementations, the update coordination component 150 alternates between adjusting values of the set of model parameters 160 using a batch of training examples from the training data 120 and adjusting values of the set of regularization parameters 170 using a batch of regularization examples from the regularization data 130. In some other implementations, the update coordination component 150 adjusts values of the set of regularization parameters 170 less frequently than values of the set of model parameters 160. In some further implementations, the update coordination component 150 adjusts different groups of regularization parameters in the set of regularization parameters 170 at different frequencies.

An example process for training a machine learning model is performed by a system of one or more computers located in one or more locations. For example, the training system 100 of FIG. 1, appropriately programmed, can perform the process.

The system obtains the set of model parameters and the set of regularization parameters of the machine learning model. The set of model parameters and the set of regularization parameters together determine outputs of the machine learning model, and values of the set of regularization parameters control an amount of regularization of the machine learning model.

The system obtains the training data and the regularization data. The regularization data is disjoint from the training data. In some implementations, obtaining the training data and the regularization data comprises partitioning a dataset into the training data and the regularization data. In some other implementations, the training data and the regularization data are obtained from separate data sources.

The system trains the set of model parameters using the training data. To train the set of model parameters, the system samples a batch of training examples from the training data, processes each training example in the batch using the machine learning model in accordance with current values of the set of model parameters and the set of regularization parameters to determine a respective model output for the training example, computes a measure of performance of the machine learning model on the batch of training examples based on the model outputs and target outputs for the training examples, computes gradients of the measure of performance with respect to the set of model parameters, and adjusts current values of the set of model parameters using the computed gradients.

The system trains the set of regularization parameters using the regularization data. To train the set of regularization parameters, the system samples a batch of regularization examples from the regularization data, processes each regularization example in the batch using the machine learning model in accordance with current values of the set of model parameters and the set of regularization parameters to determine a respective model output for the regularization example, computes a measure of performance of the machine learning model on the batch of regularization examples based on the model outputs and target outputs for the regularization examples, computes gradients of the measure of performance with respect to the set of regularization parameters, and adjusts current values of the set of regularization parameters using the computed gradients.

In some implementations, the measure of performance of the machine learning model on the training data is expressed as L_train(θ, ρ)=E_{(x, y)~D_train}[l(f(x; θ, ρ), y)], where θ denotes current values of the set of model parameters, ρ denotes current values of the set of regularization parameters, D_train denotes the training data, f(x; θ, ρ) denotes an output of the machine learning model for an input x in accordance with θ and ρ, l denotes a per-example loss between a model output and a target output y, and the expectation is taken over examples (x, y) drawn from the training data. In such implementations, the measure of performance of the machine learning model on the regularization data is expressed as L_reg(θ, ρ)=E_{(x, y)~D_reg}[l(f(x; θ, ρ), y)], where D_reg denotes the regularization data and the expectation is taken over examples drawn from the regularization data.

In some implementations, at an iteration t of the training loop, training the set of model parameters using the training data adjusts values of the set of model parameters according to θ_{t+1}=θ_t−η_θ ∇_θ L_train(θ_t, ρ_t), where η_θ is a learning rate for the set of model parameters and ∇_θ denotes a gradient with respect to the set of model parameters. Training the set of regularization parameters using the regularization data adjusts values of the set of regularization parameters according to ρ_{t+1}=ρ_t−η_ρ ∇_ρ L_reg(θ_{t+1}, ρ_t), where η_ρ is a learning rate for the set of regularization parameters and ∇_ρ denotes a gradient with respect to the set of regularization parameters. In some other implementations, the values of the set of model parameters and the values of the set of regularization parameters are adjusted using other gradient-based optimization algorithms, as described below.

In some implementations, the system adjusts values of the set of model parameters and values of the set of regularization parameters using stochastic gradient descent, Adam, RMSProp, AdamW, or another gradient-based optimization algorithm. In some implementations, a different optimization algorithm is applied to the set of model parameters than to the set of regularization parameters. In some implementations, a learning rate used for adjusting values of the set of regularization parameters is different from a learning rate used for adjusting values of the set of model parameters.

The gradients computed by the system are first-order gradients that are computed by backpropagation through the machine learning model. Computing the gradients does not comprise computing higher-order derivatives through a training trajectory of the set of model parameters. That is, the gradients with respect to the set of regularization parameters are computed by direct backpropagation of the measure of performance of the machine learning model on the regularization data through the machine learning model, using current values of the set of model parameters, rather than by differentiation of a training trajectory of the set of model parameters with respect to the set of regularization parameters.

The system determines whether training termination criteria are satisfied. Training termination criteria may comprise a maximum number of training iterations, a convergence criterion, a minimum measure of performance of the machine learning model on the regularization data, or another criterion. If the termination criteria are not satisfied, the system returns to performing further adjustments of the set of model parameters and the set of regularization parameters. If the termination criteria are satisfied, the system provides the trained machine learning model for use in processing data.

Providing the trained machine learning model for use in processing data comprises storing values of the set of model parameters and the set of regularization parameters in a computer-readable storage medium or transmitting the values to another computing system via a communication network. During inference by the trained machine learning model, both the set of model parameters and the set of regularization parameters are used to generate outputs from inputs.

In some implementations, the system applies different termination criteria to adjustment of the set of model parameters than to adjustment of the set of regularization parameters. For example, the system may continue adjusting the set of model parameters until a maximum number of training iterations have been performed, but may stop adjusting the set of regularization parameters once values of the set of regularization parameters have substantially stabilized.

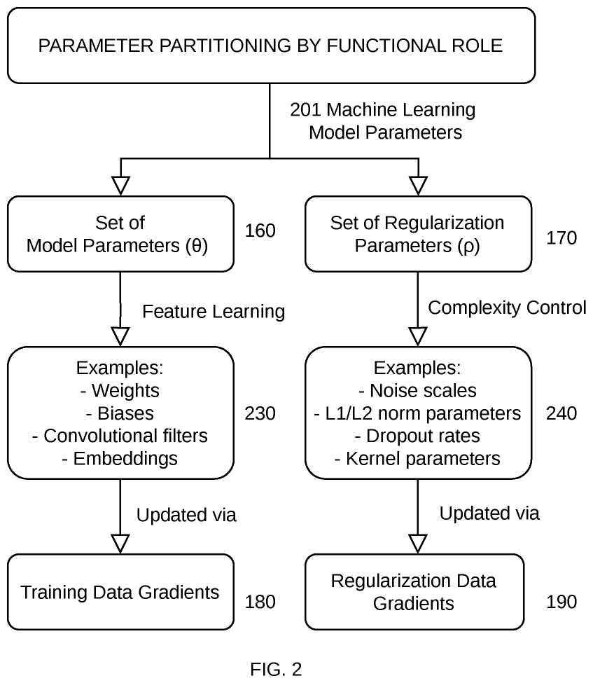

FIG. 2 illustrates an example partitioning of parameters of the machine learning model. As shown in FIG. 2, the parameters 201 of the machine learning model are partitioned into the set of model parameters 160 and the set of regularization parameters 170. The set of model parameters 160 is updated via training data gradients 180 computed from a measure of performance of the machine learning model on the training data, and the set of regularization parameters 170 is updated via regularization data gradients 190 computed from a measure of performance of the machine learning model on the regularization data. Example parameters that may be included in the set of model parameters 160 are illustrated at 230, such as weights, biases, convolutional filters, and embeddings. Example parameters that may be included in the set of regularization parameters 170 are illustrated at 240, such as norm parameters of an L1 or L2 regularization quantity, dropout rates, noise scales, and kernel parameters of a kernel-based machine learning model, such as a length scale of a radial basis function kernel or a length scale of a kernel of a Gaussian process. In some implementations, the set of model parameters and the set of regularization parameters are disjoint subsets of parameters of the machine learning model. In such implementations, adjusting values of the set of model parameters using the training data modifies values of one subset of parameters of the machine learning model, and adjusting values of the set of regularization parameters using the regularization data modifies values of a different subset of parameters of the machine learning model that is disjoint from the first subset.

The partitioning of parameters of the machine learning model into the set of model parameters and the set of regularization parameters may be based on the functional role of each parameter in operation of the machine learning model. For example, parameters that determine features extracted from inputs by the machine learning model, such as weights of convolutional filters, weights of fully-connected layers, or weights of attention projections, may be included in the set of model parameters. Parameters that control an amount of regularization applied to the machine learning model, such as a noise magnitude, a variance parameter, a temperature parameter, a label smoothing strength, a data augmentation perturbation magnitude, or a dropout probability, may be included in the set of regularization parameters.

In some other implementations, the set of model parameters and the set of regularization parameters do not correspond to disjoint subsets of parameters of the machine learning model. Instead, the set of model parameters and the set of regularization parameters correspond to adjustments of weights of the machine learning model along different directions in a parameter space.

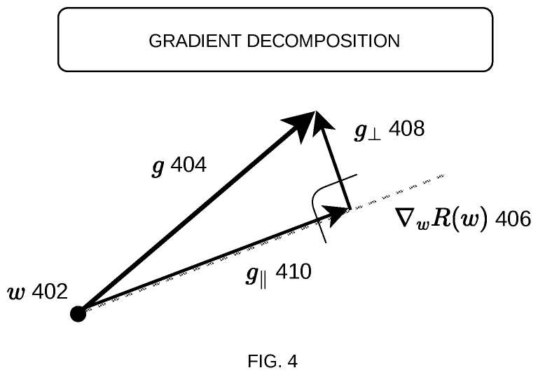

FIG. 4 is a diagram illustrating an example decomposition of a gradient in a parameter space of weights of a machine learning model. In FIG. 4, current values 402 of the weights define a point in the parameter space. A gradient 404 of a measure of performance of the machine learning model with respect to the weights indicates a direction in the parameter space along which the measure of performance changes. A regularization direction 406 is a direction in the parameter space along which a regularization quantity of the weights changes. For example, the regularization direction 406 may be a direction of a gradient of a norm of the weights evaluated at the current values 402.

The gradient 404 can be decomposed into two components: a first component 408 along a direction orthogonal to the regularization direction 406, and a second component 410 along the regularization direction 406. The first component 408 is the component of the gradient 404 in a subspace orthogonal to the regularization direction 406. Updates to the weights in the direction of the first component 408 do not change the regularization quantity, to first order. The second component 410 is the projection of the gradient 404 onto the regularization direction 406. Updates to the weights in the direction of the second component 410 change the regularization quantity.

More formally, denoting the current values 402 of the weights as w, a gradient of a measure of performance of the machine learning model with respect to the weights as g, and the regularization direction 406 as ∇_w R(w), where R is a regularization quantity of the weights, the gradient g is decomposed as g=g_\parallel +g_⊥, where g_\parallel is the projection of g onto the regularization direction and is given by g_\parallel=(∇_w R/∥∇_w R∥²) (g\hat{ }T ∇_w R), and g_⊥ is the component of g orthogonal to the regularization direction and is given by g_⊥=g−g_\parallel. In some implementations in which ∥∇_w R∥ is near zero, a normalization of ∇_w R is replaced by a nominal direction or the decomposition is skipped at that iteration.

In implementations using gradient decomposition, training the set of model parameters using the training data comprises updating the weights in a direction orthogonal to the regularization direction. Specifically, a gradient of a measure of performance of the machine learning model on the training data is computed with respect to the weights, a component of the gradient along the regularization direction is computed and subtracted from the gradient to produce an orthogonal component, and values of the weights are adjusted using the orthogonal component.

Training the set of regularization parameters using the regularization data comprises updating the weights along the regularization direction. Specifically, a gradient of a measure of performance of the machine learning model on the regularization data is computed with respect to the weights, a component of the gradient along the regularization direction is computed, and values of the weights are adjusted using the component along the regularization direction.

By decomposing updates to the weights into orthogonal and regularization-direction components and routing updates from the training data to the orthogonal component and updates from the regularization data to the regularization-direction component, the training system achieves a separation between feature learning and regularization even for regularization quantities, such as L1 norms or elastic net norms, that do not naturally admit a partition of the parameters of the machine learning model into a set of model parameters and a disjoint set of regularization parameters.

In some implementations, the regularization direction is a direction of change of an L2 norm of the weights, which is the direction of the weights themselves. In some implementations, the regularization direction is a direction of change of an L1 norm of the weights, given by ∇_w ∥w∥_1=sign(w), where sign(w) is the element-wise sign of the weights. In such implementations, the projection of the gradient onto the regularization direction is given by g_L1=(sign(w)/∥sign(w)∥²) (g\hat{ }T sign(w)). In some implementations, the regularization direction is a direction of change of an elastic net norm combining L1 and L2 components of the weights. In some implementations in which the L1 norm of the weights is not differentiable at current values of the weights, an approximate subgradient of the L1 norm is used as the regularization direction.

In some implementations, gradient decomposition is applied at a level of all weights of the machine learning model jointly. In some other implementations, gradient decomposition is applied separately to weights of each of a plurality of layers of the machine learning model. In some further implementations, gradient decomposition is applied separately to individual weights of the machine learning model.

While the example decomposition described with reference to FIG. 4 is described in terms of weights of the machine learning model and norms of the weights, gradient decomposition as described in this specification may be applied more generally to one or more parameters of the machine learning model and to a scalar function of the parameters whose value represents a regularization quantity. Weights are one example of parameters of the machine learning model, and a norm of the weights is one example of a scalar function of the parameters. Other examples of scalar functions of the parameters that may be used as regularization quantities include a spectral radius of a matrix of the parameters, an entropy of a distribution parameterized by the parameters, an effective rank of a matrix of the parameters, a total variation of the parameters, or another scalar function of the parameters whose value represents a regularization quantity. For such a scalar function, the regularization direction in parameter space is a direction of change of the scalar function, and the gradient decomposition described with reference to FIG. 4 is applied with the scalar function and its gradient in place of the norm of the weights and the gradient of the norm.

In some implementations, gradient decomposition is combined with parameter partitioning, such that some parameters of the machine learning model are partitioned into the set of model parameters and the set of regularization parameters as disjoint subsets, while updates to other parameters are decomposed into orthogonal and regularization-direction components.

In some implementations, weights of the machine learning model that are subject to norm-based regularization are represented as a product of a direction parameter and a magnitude parameter. The direction parameter is a unit vector that parameterizes a direction of the weights in parameter space. The magnitude parameter is a scalar that parameterizes a magnitude of the weights, that is, a norm of the weights. The direction parameter is included in the set of model parameters, and the magnitude parameter is included in the set of regularization parameters.

Training the direction parameter using the training data adjusts the direction of the weights based on a measure of performance of the machine learning model on the training data, such as a cross-entropy loss or a mean squared error on the training data. Training the magnitude parameter using the regularization data adjusts the norm of the weights based on a measure of performance of the machine learning model on the regularization data.

In some implementations in which the weights are represented as a product of a direction parameter and a magnitude parameter, a constraint that the direction parameter is a unit vector is enforced by projecting the direction parameter onto a unit sphere after each adjustment of the direction parameter.

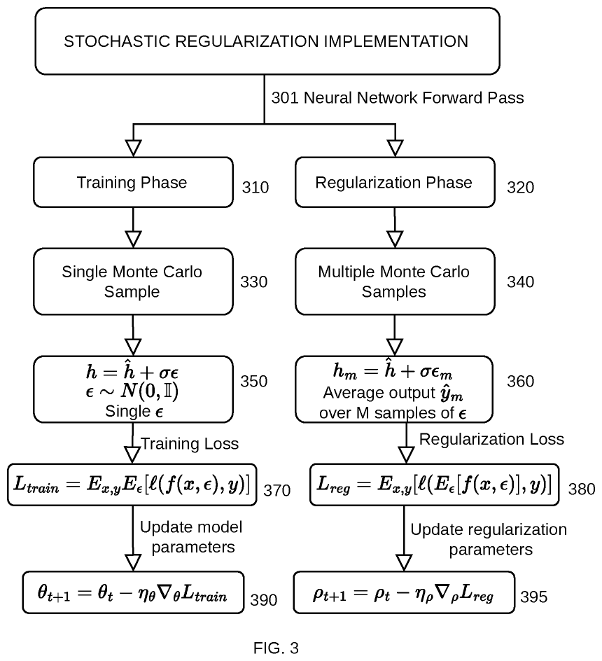

FIG. 3 illustrates an example treatment of a stochastic component of a machine learning model during training. As shown in FIG. 3, a forward pass 301 of the machine learning model operates in two phases: a training phase 310, in which a single Monte Carlo sample 330 is drawn from the stochastic component for each training example in the training data, and a regularization phase 320, in which a plurality of Monte Carlo samples 340 are drawn from the stochastic component for each regularization example in the regularization data. In the training phase 310, a single-sample stochastic substitution 350, in which the stochastic component takes the value of the single sample 330, is applied during the forward pass, and a training loss 370 is computed from a model output produced by the forward pass with the single-sample stochastic substitution 350 applied. The training loss 370 is used to update the set of model parameters at 390. In the regularization phase 320, a multi-sample stochastic substitution 360 is applied, in which the stochastic component takes each value of the plurality of samples 340 in turn and outputs of the machine learning model are averaged across the plurality of samples 340, and a regularization loss 380 is computed from the averaged output. The regularization loss 380 is used to update the set of regularization parameters at 395. In some implementations, the machine learning model comprises a stochastic component parameterized by one or more regularization parameters in the set of regularization parameters. The stochastic component may comprise a noise distribution from which samples are drawn and applied to activations, weights, or inputs of the machine learning model during processing of inputs. The stochastic component may also comprise a dropout distribution over dropout masks applied to activations of the machine learning model during processing of inputs. While FIG. 3 depicts an embodiment in which the stochastic component comprises additive Gaussian noise applied to activations of the machine learning model, the stochastic component may more generally comprise any of the forms described in this specification, including noise applied to weights of the machine learning model, noise applied to inputs of the machine learning model, a dropout distribution applied to activations of the machine learning model, or another form of stochastic component parameterized by one or more regularization parameters in the set of regularization parameters.

As used in this specification, a stochastic component of the machine learning model whose parameters are included in the set of regularization parameters is referred to as a stochastic component for the purposes of the asymmetric treatment described with reference to FIG. 3. The machine learning model may also comprise other stochastic components whose parameters are not included in the set of regularization parameters. For example, the machine learning model may comprise a Bayesian or variational machine learning model having a stochastic posterior distribution over outputs, an ensemble of a plurality of machine learning components, a generative model comprising stochastic latent variables, or another source of stochasticity in generating outputs from inputs. The asymmetric treatment described with reference to FIG. 3 applies to the stochastic component of the machine learning model whose parameters are included in the set of regularization parameters and does not restrict other stochasticity in operation of the machine learning model.

When training a machine learning model with a stochastic component whose parameters are included in the set of regularization parameters, the training system uses an asymmetric measure of performance for the training data and the regularization data, in which the stochastic component is sampled a greater number of times per example when computing the measure of performance on the regularization data than when computing the measure of performance on the training data. In some implementations, for each training example in the training data, the system samples a single sample from the stochastic component, determines an output of the machine learning model using the single sample, and computes a loss using the determined output and a target output for the training example. In some other implementations, for each training example, the system samples a plurality of samples from the stochastic component and computes a loss based on the samples, where the plurality of samples is smaller than a plurality of samples used per regularization example as described below. The measure of performance of the machine learning model on the training data is an average of the losses across training examples in the training data.

For each regularization example in the regularization data, the system samples a plurality of samples from the stochastic component, determines a respective output of the machine learning model for each of the plurality of samples, aggregates the outputs across the plurality of samples to determine an aggregated output, and computes a loss using the aggregated output and a target output for the regularization example. Aggregation across the plurality of samples may comprise averaging the outputs, computing a weighted average of the outputs, or another operation that combines the plurality of outputs into a single output. The plurality of samples per regularization example is greater in number than the samples per training example. The measure of performance of the machine learning model on the regularization data is an average of the losses across regularization examples in the regularization data.

More formally, in some implementations in which the machine learning model comprises a stochastic component parameterized by one or more regularization parameters in ρ, a sample from the stochastic component is denoted ε, and an output of the machine learning model for an input x using a sample ε of the stochastic component is denoted f(x, ε; θ, ρ). The measure of performance of the machine learning model on the training data in such implementations is expressed as L_train(θ, ρ)=E_{(x, y)~D_train} E_ε[l(f(x, ε; θ, ρ), y)], where the per-example loss is computed using a single sample of ε and the expectation E_ε is approximated in practice by drawing one sample of ε per training example. The measure of performance of the machine learning model on the regularization data in such implementations is expressed as L_reg(θ, ρ)=E_{(x, y)~D_reg}[l(E_ε[f(x, ε; θ, ρ)], y)], where the expectation E_ε[f(x, ε; θ, ρ)] of an output of the machine learning model over samples of the stochastic component is approximated in practice by averaging outputs of the machine learning model across a plurality of samples of ε drawn for each regularization example and the per-example loss is computed using the averaged output.

If the stochastic component were deterministic, for example by setting ε to a fixed value, the measure of performance of the machine learning model on the regularization data would be independent of parameters of the stochastic component, and gradients of the measure of performance on the regularization data with respect to parameters of the stochastic component would vanish. By averaging outputs of the machine learning model across a plurality of samples of ε in the measure of performance on the regularization data, gradients of the measure of performance on the regularization data with respect to parameters of the stochastic component are nonzero and are used to adjust values of the parameters of the stochastic component during training.

Training the set of model parameters using the measure of performance on the training data computed from single-sample outputs maintains a regularizing effect of the stochastic component. In particular, when the loss is non-linear in the model output, the expected single-sample loss differs from the loss computed on an averaged output by an amount that depends on the stochastic component. Training the set of model parameters to minimize the expected single-sample loss exposes the machine learning model to randomness from the stochastic component and drives the machine learning model to produce outputs that are robust to the randomness.

Training the set of regularization parameters using the measure of performance on the regularization data computed from averaged outputs approximates a performance of the machine learning model with the stochastic component integrated out. This performance is the quantity relevant for generalization to data outside the training data, in which the stochastic component is used to approximate an expectation over possible outputs of the machine learning model rather than to introduce regularization.

In some implementations, the number of samples drawn from the stochastic component for each regularization example is in a range from approximately 3 samples to approximately 10 samples. The number of samples may be determined based on computational constraints and desired accuracy of gradient estimates.

In some implementations, gradients of the measure of performance of the machine learning model on the regularization data with respect to a noise magnitude that parameterizes a continuous noise distribution are computed using a reparameterization trick in which samples from the noise distribution are expressed as a deterministic function of the noise magnitude and samples from a fixed base distribution. For example, samples from a Gaussian distribution with zero mean and standard deviation sigma can be expressed as the product of sigma and samples from a standard Gaussian distribution with zero mean and unit variance, and gradients with respect to sigma can be computed by backpropagation through this deterministic function.

In some implementations in which a regularization parameter parameterizes a discrete distribution, such as a dropout probability that parameterizes a Bernoulli distribution over dropout masks, a continuous relaxation of the discrete distribution is used during training of the regularization parameter to enable computation of gradients with respect to the regularization parameter. Examples of continuous relaxations include a concrete distribution and a Gumbel-softmax distribution.

In some implementations, the set of regularization parameters comprises one or more parameters of a predictive distribution of the machine learning model. The predictive distribution is a distribution over possible outputs of the machine learning model given an input. For example, for a classification task, the predictive distribution may be a categorical distribution over class labels generated by applying a softmax function to logits output by the machine learning model. For a regression task, the predictive distribution may be a Gaussian distribution with a mean equal to an output of the machine learning model and a variance that is a regularization parameter in the set of regularization parameters. The predictive distribution may also be a mixture distribution over a plurality of component distributions, in which case the set of regularization parameters may comprise parameters that control dispersion of the mixture distribution or of its component distributions. The predictive distribution may also be another distribution over possible outputs appropriate for a task being learned by the machine learning model.

The parameters of the predictive distribution that are included in the set of regularization parameters may comprise parameters that control a dispersion of the predictive distribution. Examples of dispersion-controlling parameters include a variance parameter of a Gaussian output distribution, a temperature parameter applied to logits prior to a softmax function, a precision parameter of a Dirichlet distribution, a scale parameter of a Student t distribution, or another parameter that controls dispersion of the predictive distribution. The set of regularization parameters may further comprise variance or precision parameters of a posterior distribution over outputs in a Bayesian or variational machine learning model, while mean parameters of the posterior distribution are included in the set of model parameters.

Training the parameters of the predictive distribution using the regularization data comprises computing a measure of performance of the machine learning model on the regularization data that is based on a likelihood of target outputs in the regularization data under the predictive distribution generated by the machine learning model for corresponding inputs in the regularization data. Training adjusts the parameters of the predictive distribution so that the likelihood of target outputs in the regularization data is increased.

By training the parameters of the predictive distribution on the regularization data using a likelihood-based measure of performance during the training process, the predictive distribution of the trained machine learning model is calibrated with respect to data outside the training data without requiring a separate post-training calibration step. In contrast, a predictive distribution obtained by training the machine learning model with fixed values of the parameters of the predictive distribution can be miscalibrated on data outside the training data, and producing a calibrated predictive distribution in such cases conventionally requires a separate post-training calibration step such as temperature scaling applied to outputs of the trained machine learning model. Training the parameters of the predictive distribution on the regularization data during the training process avoids the separate post-training calibration step and adjusts the parameters of the predictive distribution jointly with the set of model parameters, such that the trained predictive distribution reflects actual uncertainty of the machine learning model on data not seen during training of the set of model parameters.

The trained predictive distribution may be used at test time to represent uncertainty of the machine learning model about its predictions. For example, a wider predictive distribution indicates higher uncertainty, and a narrower predictive distribution indicates lower uncertainty.

The set of regularization parameters may have various levels of granularity within the machine learning model. In some implementations, the set of regularization parameters comprises a single regularization parameter that controls regularization globally across the machine learning model. For example, a single noise magnitude may parameterize a noise distribution applied to all activations of the machine learning model.

In some implementations, the set of regularization parameters comprises multiple regularization parameters, wherein different regularization parameters in the set control regularization of different parts of the machine learning model. For example, the machine learning model may comprise a plurality of layers, and the set of regularization parameters may comprise, for each of the plurality of layers, one or more respective regularization parameters that control regularization of the layer.

In some implementations, the machine learning model comprises individual parameters that each have an associated regularization parameter in the set of regularization parameters. For example, each weight of the machine learning model may have an associated noise magnitude that parameterizes a perturbation applied specifically to that weight.

By employing different granularities of regularization parameters, the training system can adapt an amount of regularization applied to different parts of the machine learning model based on the characteristics of those parts. For example, parts of the machine learning model that overfit more strongly to the training data may be trained to have larger regularization, while parts that underfit may be trained to have smaller regularization.

In some implementations, the training data and the regularization data are drawn from a non-stationary distribution in which a distribution of inputs, a distribution of target outputs, or both, changes over time during training. For example, in an online learning scenario, the training data and the regularization data may correspond to observations received from an environment whose statistics change over time.

By adjusting values of the set of regularization parameters based on measures of performance of the machine learning model on current regularization data throughout training, the training system adapts values of the set of regularization parameters to the current distribution of the training data and the regularization data. As the distribution of the data changes, the measures of performance on the regularization data change, and the gradients of the measures of performance with respect to the set of regularization parameters correspondingly change, leading to adjustments of the set of regularization parameters that reflect the current distribution.

As a result, the machine learning model adjusts an amount of regularization in response to changes in the distribution of the data without requiring explicit detection of distribution shifts or restarting of training. This makes the training system applicable to domains with evolving data distributions, such as financial markets, online advertising, and sensor data from evolving physical environments.

In some implementations, the training system adjusts values of the set of model parameters and values of the set of regularization parameters in alternation. At each iteration of a training loop, the training system first performs an adjustment of values of the set of model parameters using a batch of examples from the training data, and then performs an adjustment of values of the set of regularization parameters using a batch of examples from the regularization data.

In some implementations, the training system adjusts values of the set of regularization parameters less frequently than values of the set of model parameters. For example, the training system may adjust values of the set of model parameters at every training iteration and adjust values of the set of regularization parameters once every k training iterations, for some positive integer k greater than 1. In some implementations, k is determined based on computational budget or based on a measured rate of change of values of the set of regularization parameters.

In some implementations, the set of regularization parameters comprises a plurality of groups of regularization parameters, and different groups are adjusted in separate adjustment operations. For example, per-layer regularization parameters may be updated together as a group in one operation, and a global regularization parameter may be updated in a separate operation.

In some implementations, different groups of regularization parameters are adjusted at different frequencies during training. For example, faster-changing regularization parameters may be adjusted at every iteration, while slower-changing regularization parameters may be adjusted only every several iterations.

In some implementations, the set of regularization parameters comprises regularization parameters arranged in a hierarchy, wherein values of higher-level regularization parameters influence regularization applied by lower-level regularization parameters. Both the higher-level regularization parameters and the lower-level regularization parameters are adjusted during training. For example, a higher-level regularization parameter may determine a common prior over values of a plurality of lower-level regularization parameters that control regularization of respective parts of the machine learning model, and adjusting values of the higher-level regularization parameter affects regularization applied by the corresponding lower-level regularization parameters.

In some implementations, the machine learning model comprises a neural network. The neural network may comprise a feedforward neural network, a convolutional neural network, a recurrent neural network, a transformer neural network, another neural network architecture, or a combination of these. The set of model parameters may comprise weights and biases of layers of the neural network, and the set of regularization parameters may comprise regularization parameters applied globally to the neural network or regularization parameters applied to specific layers of the neural network.

In some implementations, the machine learning model is configured to perform a classification task, in which inputs to the machine learning model comprise feature vectors, images, text, or other data, and outputs of the machine learning model comprise scores for each of a plurality of classes.

In some implementations, the machine learning model is configured to perform a regression task, in which outputs of the machine learning model comprise predicted continuous-valued quantities. The machine learning model may output a Gaussian predictive distribution, with a mean output by the machine learning model and a variance that is a regularization parameter in the set of regularization parameters.

In some implementations, the machine learning model is configured to perform a structured prediction task, in which outputs of the machine learning model comprise structured outputs such as sequences of tokens, graphs, or trees.

In some implementations, the machine learning model is configured to perform a generative modeling task, in which the machine learning model generates outputs that are instances of a distribution of training data.

In some implementations, the machine learning model is configured to perform an uncertainty quantification task, in which the machine learning model outputs predictive distributions representing uncertainty about its predictions. In such implementations, the set of regularization parameters may comprise parameters of the predictive distributions that are adjusted based on likelihood of target outputs in the regularization data under the predictive distributions.

After training, the training system provides the trained machine learning model for use in processing data. Providing the trained machine learning model may comprise storing values of the set of model parameters and the set of regularization parameters in a computer-readable storage medium or transmitting the values to another computing system via a communication network.

During inference by the trained machine learning model, both the set of model parameters and the set of regularization parameters are used to generate outputs from inputs. That is, the values of the set of regularization parameters adjusted during training are part of the trained machine learning model and participate in producing outputs at inference time, rather than being used only during training and discarded afterward.

In some implementations, inference by the trained machine learning model comprises processing an input using the machine learning model in accordance with values of the set of model parameters and values of the set of regularization parameters to produce an output or a predictive distribution over outputs. In some implementations in which the set of regularization parameters comprises parameters of a predictive distribution, the output of inference includes both a point prediction and a predictive distribution representing uncertainty about the point prediction.

In some implementations, the trained values of the set of regularization parameters are transferred to another training process for use in training another machine learning model. For example, the trained values of the set of regularization parameters may be used as initial values of a set of regularization parameters of a second machine learning model that is trained on a second training data and a second regularization data, where the second machine learning model may have a same or different architecture as the machine learning model and the second training data may be drawn from a same or related data distribution as the training data. In some implementations, the trained values of the set of regularization parameters are used as initial values for further training of the machine learning model on additional training data and additional regularization data, for example in a fine-tuning process or a continual learning process in which the machine learning model is adapted to a new data distribution or a new task. In some implementations, the trained values of the set of regularization parameters are used to initialize regularization parameters of a larger or smaller machine learning model, for example by replicating the trained values across parts of the larger machine learning model or by averaging the trained values across parts of the smaller machine learning model. Transferring trained values of the set of regularization parameters in this manner can reduce the number of iterations required to train a subsequent machine learning model to acceptable generalization performance, as compared to initializing the set of regularization parameters for the subsequent machine learning model from default values.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification, the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for training a machine learning model, the method comprising:
maintaining, in computer memory, a machine learning model comprising a first set of parameters and a second set of parameters disjoint from the first set, wherein the first set of parameters appears in an inference function of the model that produces an output from an input;
accessing a first dataset and a second dataset disjoint from the first dataset; and
training the machine learning model over a plurality of iterations, wherein for each iteration of the plurality of iterations:
obtaining a first batch of training examples from the first dataset;
computing a first loss as a function of the first batch, the first set of parameters, and the second set of parameters;
computing a first gradient of the first loss with respect to the first set of parameters;
updating the first set of parameters using the first gradient;
obtaining a second batch of training examples from the second dataset;
computing a second loss as a function of the second batch, the first set of parameters as updated in the iteration, and the second set of parameters;
computing a second gradient of the second loss with respect to the second set of parameters; and
updating the second set of parameters using the second gradient.

2. The method of claim 1, wherein the second set of parameters comprises one or more parameters that parameterize a probability distribution over noise applied within the machine learning model during training.

3. The method of claim 2, wherein the probability distribution is a Gaussian distribution and the one or more parameters comprise a standard deviation of the Gaussian distribution.

4. The method of claim 1, wherein the second set of parameters comprises one or more of: a magnitude of a penalty applied to the first set of parameters, a parameter controlling a distribution over data augmentation transformations differentiable with respect to the second set of parameters, a temperature parameter of a softmax operation, or a variance parameter of a variational posterior distribution over at least a subset of the first set of parameters.

5. The method of claim 1, wherein the second set of parameters comprises a respective parameter associated with each of a plurality of layers, a plurality of units, a plurality of feature maps, or a plurality of attention heads of the machine learning model.

6. The method of claim 1, wherein the machine learning model produces probabilistic predictions, and training the machine learning model over the plurality of iterations causes an expected calibration error of the machine learning model, measured on data drawn from a common distribution with the second dataset, to decrease over the plurality of iterations.

7. The method of claim 1, wherein for at least one iteration of the plurality of iterations, computing the second loss comprises:
generating a plurality of model outputs for the second batch, each model output generated using a respective noise sample drawn from a probability distribution parameterized by the second set of parameters;
computing an averaged model output by averaging the plurality of model outputs; and
computing the second loss as a function of the averaged model output and labels associated with the second batch;
and wherein computing the first loss comprises generating a single model output for the first batch using a single noise sample drawn from the probability distribution.

8. The method of claim 1, wherein the machine learning model comprises a pre-trained transformer language model, the first set of parameters comprises parameters of one or more low-rank adaptation matrices added to the transformer language model, and parameters of the transformer language model other than the low-rank adaptation matrices are held fixed during the plurality of iterations.

9. The method of claim 1, wherein the updating of the second set of parameters is performed once per k iterations of the plurality of iterations, where k is an integer greater than or equal to 1, and wherein updating the first set of parameters is performed according to a first optimizer and updating the second set of parameters is performed according to a second optimizer different from the first optimizer.

10. The method of claim 1, further comprising, after the plurality of iterations, deploying the machine learning model for inference on new inputs using the first set of parameters and the second set of parameters as obtained at a final iteration of the plurality of iterations.

11. A method performed by one or more computers for training a machine learning model, the method comprising:
maintaining, in computer memory, a machine learning model comprising a set of parameters, wherein the machine learning model is associated with a regularization function of the set of parameters;
accessing a first dataset and a second dataset disjoint from the first dataset; and
training the machine learning model over a plurality of iterations, wherein for each iteration of the plurality of iterations:
obtaining a first batch of training examples from the first dataset;
computing a first gradient of a first loss with respect to the set of parameters, the first loss being a function of the first batch and the set of parameters;
determining a first complexity direction as a direction of a gradient of the regularization function at current values of the set of parameters;
decomposing the first gradient into a first complexity component aligned with the first complexity direction and a first orthogonal component orthogonal to the first complexity direction;
updating the set of parameters using the first orthogonal component;
obtaining a second batch of training examples from the second dataset;
computing a second gradient of a second loss with respect to the set of parameters, the second loss being a function of the second batch and the set of parameters as updated in the iteration;
determining a second complexity direction as a direction of a gradient of the regularization function at current values of the set of parameters;
decomposing the second gradient into a second complexity component aligned with the second complexity direction and a second orthogonal component orthogonal to the second complexity direction; and
updating the set of parameters using the second complexity component.

12. The method of claim 11, wherein the regularization function comprises an L1 norm, an elastic net combination of an L1 norm and an L2 norm, a nuclear norm, a group sparsity norm, or a total variation penalty over at least a subset of the set of parameters.

13. The method of claim 11, wherein at one or more points at which the gradient of the regularization function is undefined, the first complexity direction or the second complexity direction is determined using a subgradient of the regularization function.

14. A system for training a machine learning model, the system comprising:
one or more computers; and
one or more storage devices storing instructions that, when executed by the one or more computers, cause the one or more computers to perform operations comprising:
maintaining a machine learning model comprising a first set of parameters and a second set of parameters disjoint from the first set, wherein the first set of parameters appears in an inference function of the model that produces an output from an input;
accessing a first dataset and a second dataset disjoint from the first dataset; and
training the machine learning model over a plurality of iterations, wherein for each iteration of the plurality of iterations the operations further comprise:
obtaining a first batch of training examples from the first dataset;
computing a first loss as a function of the first batch, the first set of parameters, and the second set of parameters;
computing a first gradient of the first loss with respect to the first set of parameters;
updating the first set of parameters using the first gradient;
obtaining a second batch of training examples from the second dataset;
computing a second loss as a function of the second batch, the first set of parameters as updated in the iteration, and the second set of parameters;
computing a second gradient of the second loss with respect to the second set of parameters; and
updating the second set of parameters using the second gradient.

15. The system of claim 14, wherein the one or more storage devices comprise a first memory region storing the first set of parameters and a second memory region storing the second set of parameters, the first memory region being separate from the second memory region.

16. The system of claim 14, wherein the one or more computers comprise a plurality of hardware processing units configured to generate, in parallel, a plurality of model outputs for the second batch using respective noise samples drawn from a probability distribution parameterized by the second set of parameters.

17. The method of claim 1, wherein an assignment of a parameter to the first set of parameters or to the second set of parameters is determined by a functional role of the parameter in the machine learning model, and wherein a parameter of a given type is assigned to the first set of parameters in a first machine learning model and to the second set of parameters in a second machine learning model.

18. The method of claim 1, wherein the second set of parameters is continuously differentiable with respect to the second loss.

19. The method of claim 1, wherein the first dataset and the second dataset are sampled from a common data-generating distribution.

20. The method of claim 1, wherein the machine learning model is a neural network, the first set of parameters comprises weights and biases of the neural network, and the second set of parameters is disjoint from said weights and biases.
